(19) United States
(12) Patent Application Publication
(10) Pub. No.: US 2023/0150056 A1
(43) Pub. Date: May 18, 2023

(54) AN AUTOMATIC SURFACE TRACING METHOD, SYSTEM, AND STORAGE MEDIUM FOR LASER PROCESSING

(71) Applicant: INNOFOCUS PHOTONICS TECHNOLOGY PTY LTD, Shenzhen, Guangdong (CN)

(72) Inventors: Jinchuan ZHENG, Victoria (AU); Han LIN, Victoria (AU); Baohua JIA, Victoria (AU)

(21) Appl. No.: 17/907,389

(22) PCT Filed: Jul. 1, 2020
(86) PCT No.: PCT/CN2020/099657

§ 371 Date: Sep. 26, 2022

(30) Foreign Application Priority Data
Mar. 27, 2020 (CN) 202010230280.0

(51) Int. Cl. B23K 26/04; B23K 26/03

(52) U.S. Cl. CPC B23K 26/048; B23K 26/032

(57) ABSTRACT

An automatic surface tracing method, system, and storage medium are for laser processing. The method includes, at the initial moment, identifying the state of the laser beam on the surface of the workpiece to be processed. If the state is in an out-of-focus state, the relative distance between the microscope objective and the surface of the workpiece to be processed is adjusted, and the state is simultaneously identified until it is identified as an in-focus state. The method for identifying the state of the laser beam includes capturing a position image of the laser beam on the surface of the workpiece to be processed in real-time, and identifying the state of the laser beam accordingly. The method can effectively improve the processing success rate, processing quality and processing accuracy, and is economical and efficient.

This application claims the priority of the Chinese patent application filed on Mar. 27, 2020, with the application number of 202010230280.0 and the invention titled “an automatic surface tracing method, system, and storage medium for laser processing”, which the entire contents of this application are incorporated by reference.

### TECHNICAL FIELD

The invention relates to the technical field of laser processing, in particular to an automatic surface tracing method, system, and storage medium for laser processing.

### TECHNICAL BACKGROUND

Laser nanofabrication, also known as laser 3D nanoprinting technology, has the advantages of simple processing equipment, fast and low-cost fabrication process, and 3D processing capability. It has become one of the most crucial emerging high-precision manufacturing technologies.

Laser 3D nanoprinting technology uses high light intensity in the focal region of a tightly focused laser beam that is usually focused by a microscope objective to the processing position. The laser focus is used to modify material properties to fabricate structures with nanometer precision in different materials (including polymers, glass, metals, new two-dimensional materials, etc.).

Using femtosecond laser 3D nanoprinting technology, structures with different functions can be fabricated, including polymer photonic crystal structures, ultrathin microlenses, miniature optical waveguides, and fiber gratings. Moreover, it has high spatial resolution due to the small affected area, and can achieve nanometer positioning accuracy. Therefore, it has attracted extensive attention in micro/nanofabrications requiring ultrahigh precision.

Due to the high 3D precision of laser nanofabrication, it is particularly critical to control the relative position of the laser focus and the workpiece to be processed. However, in the fabrication (or manufacturing) process using laser 3D nanofabrication, the laser beam often cannot be accurately focused on the desired position due to the uneven surface and deformation of the workpiece, tilt, or external mechanical impact and vibration. This can lead to a decrease in precision in the laser nanofabrication process, thereby reducing the fabrication quality and affecting the yield.

### SUMMARY OF THE INVENTION

The purpose of the present invention is to provide an automatic surface tracing method, system, and storage media for laser nanofabrication to solve the problem that the laser nanofabrication accuracy in the prior art is easily affected by workpiece surface roughness, tilt, deformation, or external mechanical impact.

For this purpose, the present invention adopts the following technical solutions:

An automatic surface tracing method for laser nanofabrication, comprising:

At the initial moment, the method identifies the state of the laser beam on the surface of the workpiece to be processed. If the state of the laser beam is out-of-focus, it adjusts the relative distance between the microscope objective and the surface of the workpiece to be processed so as to adjust the laser focal position relative to the surface of the workpiece to be processed. The height adjustment operation is performed, and the state of the laser beam is identified at the same time until it is determined that the laser beam is in-focus. Here, the in-focus state is defined as the laser focus at the workpiece's surface.

The method for identifying the state of the laser spot includes: capturing a position image of the laser beam on the surface of the workpiece and recognizing the state of the laser spot according to the position image.

Optionally, identifying the state of the laser spot according to the position image includes:

According to the position image, the method calculates the laser beam's average light intensity on the workpiece's surface to be processed, and the laser irradiation area at least covers the laser beam area on the surface of the workpiece.

Comparing the average light intensity with a light intensity threshold, where the light intensity threshold is a preset minimum light intensity required to indicate that the laser beam is in-focus.

If the average light intensity is lower than the light intensity threshold, it is determined that the laser beam is out-of-focus. If the average light intensity is not lower than the light intensity threshold, the laser beam is in-focus

Optionally, calculating the average light intensity of the laser beam on the surface of the workpiece includes:

Calculating the gray value of the laser beam area in the image;

The grayscale value is calculated and converted to obtain the average light intensity.

Optionally, identifying the state of the laser beam according to the position image includes:

Calculating the size of the laser beam in the image.

Comparing the size of the laser beam with a size threshold, where the size threshold is a preset maximum size required to indicate that the laser beam is in-focus.

If the size of the laser beam is smaller than the size threshold, the laser beam is determined to be in-focus. If the size of the laser spot is larger than the size threshold, the laser beam is out-of-focus.

Optionally, the height adjustment operation includes:

When the laser beam is out-of-focus, the method identifies whether the shape of the laser beam in the image is symmetric.

If it is symmetric, it is determined that the focal position is too shallow, and the focal position is controlled to step down from the current height according to a preset step distance.

If it is asymmetric, it is determined that the focal position is too deep, and the focal position is controlled to step up from the current height according to a preset step distance.

Optionally, the height adjustment operation includes:

When the laser beam is out-of-focus, it is determined whether the focal position is too deep or too shallow according to the angle between the long axis direction of the elliptical laser beam in the image and the specified direction. The specified direction is defined by the user.

If the focal position is too shallow, the focal position is controlled to step down from the current height according to the preset step distance.

If the focal position is too deep, the focal position is controlled to step up from the current height according to a preset step distance.

Optionally, the height adjustment operation includes:

First, the focal position is controlled to step up to a preset first height from the current height, and then the focal position is controlled to step down according to a preset step distance.

An automatic surface tracing system comprises a microscope objective for focusing a laser beam. The system further comprises: an image sensor, a driver, a focus detector, and an adjustment controller;

The image sensor is used to capture the laser beam's position image on the workpiece's surface.

The driver is used for adjusting the relative distance between the microscope objective and the surface of the workpiece according to the control command of the adjustment controller so as to adjust the height of the laser focal position relative to the surface of the workpiece.

The focus detector is used to identify the state of the laser beam according to the captured position image at the initial moment and during the height adjustment operation. If it is determined that the laser beam is out-of-focus, the detector sends the adjustment controller an out-of-focus signal. If the laser beam is determined to be in-focus, it sends an in-focus signal to the adjustment controller.

The adjustment controller is configured to control the driver to perform the height adjustment operation according to a preset height control algorithm when an out-of-focus signal is received at the initial moment until an in-focus signal is received.

Optionally, the focus detector includes:

An average light intensity calculation module is configured to calculate the average light intensity of the laser beam on the surface of the workpiece according to the position image. The laser irradiation area at least covers the laser beam area on the surface of the workpiece.

A light intensity comparison module is configured to compare the average light intensity with a light intensity threshold. The light intensity threshold is a preset minimum light intensity required to indicate that the laser beam is in-focus. If the average light intensity is lower than the light intensity threshold, it is determined that the laser beam is out-of-focus. If the average light intensity is not lower than the light intensity threshold, the laser beam is determined to be in-focus.

Optionally, the average light intensity calculation module, when calculating the average light intensity, is specifically configured to: calculate the grayscale value of the laser beam in the position image; convert the calculated grayscale value to the average light intensity.

Optionally, the focus detector includes:

A laser beam size calculation module is used to calculate the size of the laser beam in the position image;

A laser beam size comparison module is configured to compare the size of the laser beam with a size threshold, where the size threshold is a preset maximum size required to indicate that the laser beam is in-focus. If the size of the laser beam is smaller than the size threshold, it is determined that the laser beam is in-focus. If the size of the laser beam is not smaller than the size threshold, it is determined that the laser beam is out-of-focus.

Optionally, the focus detector further includes a focal depth identification module, used to identify whether the shape of the laser beam in the image is symmetric when the laser beam is out-of-focus. If it is symmetric, the focal position is too shallow. Otherwise, the focal position is too deep.

When performing the height adjustment operation, the adjustment controller is specifically configured. If the focal position is too shallow, the focal position is controlled to step down from the current height according to a preset step distance. If the focal position is too deep, the focal position is controlled to step up from the current height according to a preset step distance.

Optionally, the focus detector further includes a focal depth identification module. When the laser beam is out-of-focus, according to the angle between the long axis direction of the elliptical laser beam in the position image and the specified direction, the module is used to determine whether the focal position is too shallow or too deep.

When performing the height adjustment operation, the adjustment controller is specifically configured. If the focal position is too shallow, the focal position is controlled to step down from the current height according to a preset step distance. If the focal position is too deep, the focal position is controlled to step up from the current height according to a preset step distance.

Optionally, the adjustment controller, when controlling the driver to perform the height adjustment operation, is specifically used for:

First, the focal position is controlled to step up to a preset first height from the current height, and then the focal position is controlled to step down according to a preset step distance.

A storage medium storing a plurality of instructions, the instructions are loaded by processors to execute the steps in any of the methods mentioned above for automatic surface tracing.

Compared with the prior art, the embodiments of the present invention have the following advantages:

In the embodiment of the present invention, while adjusting the relative position of the focal position and the workpiece, the image recognition technology is used to identify the state of the laser beam in real-time until the laser beam is in-focus, regardless of the flatness of the surface of the workpiece or whether it is affected by external impact. The method can adjust the laser beam to be in-focus, effectively improving the processing success rate, processing quality, and processing accuracy.

At the same time, since the embodiment of the present invention is mainly implemented by software, the hardware part only needs to use a low-cost image sensor, so there is no need for major changes to the existing laser processing device, which is economical and efficient.

### DESCRIPTION OF DRAWINGS

In order to explain the embodiments of the present invention or the technical solutions in the prior art more clearly, the following briefly introduces the accompanying drawings that need to be used in the description of the embodiments or the prior art. Obviously, the accompanying drawings in the following description are only some embodiments of the present invention. For those of ordinary skill in the technical field, other drawings can also be obtained based on these drawings without any creative effort.

FIG. 1 is a flowchart of the automatic surface tracing method provided by an embodiment of the present invention;

FIG. 2 is a flowchart of the adjustment control method provided by an embodiment of the present invention;

FIG. 3 is an exemplary diagram of a height adjustment control curve of a laser focus provided by an embodiment of the present invention;

FIG. 4 is another exemplary diagram of a height adjustment control curve of a laser focus provided by an embodiment of the present invention;

FIG. 5 is a flowchart of a method for realizing height adjustment based on the symmetry of a spot shape provided by an embodiment of the present invention;

FIG. 6 is a flowchart of a method for realizing height adjustment based on the long-axis direction of an elliptical laser beam provided by an embodiment of the present invention;

FIG. 7 is a structural diagram of an automatic surface tracing system provided by an embodiment of the present invention.

### DETAILED IMPLEMENTATION METHODS

In order to make those skilled people in the field better understand the embodiments of the present invention, the following will clearly and completely describe the technical solutions in the embodiments of the present invention with reference to the accompanying drawings in the embodiments of the present invention. Obviously, the described implementations of the examples are only a part of the embodiments of the present invention, but not all of the embodiments. Based on the examples in the embodiments of the present invention, all other embodiments obtained by persons of ordinary skill in the field without creative work shall fall within the protection scope of the embodiments of the present invention.

The terms “comprising” and “having” in the description and claims of the embodiments of the present invention and the above-mentioned drawings and any variations thereof are intended to cover non-exclusive inclusion, for example, a process comprising a series of steps or units, a method, system, product or device is not necessarily limited to those steps or units expressly listed, but may include other steps or units not expressly listed or inherent to the process, method, product or device.

It should be noted that the existing laser processing system mainly includes: a laser and a microscope objective. Among them, the laser is used to output the laser beam; the microscope objective is used to focus the laser beam.

In order to accurately focus the laser beam on the surface of the workpiece so as to utilize the high light intensity at the laser focus to achieve efficient and accurate laser nanofabrication on the workpiece, the embodiment of the present invention provides an automatic surface tracing method suitable for laser processing, mainly through image recognition technology and control algorithm technology, the laser beam the surface of the workpiece can be kept in-focus, thereby effectively ensuring the processing accuracy and improving the processing quality and yield.

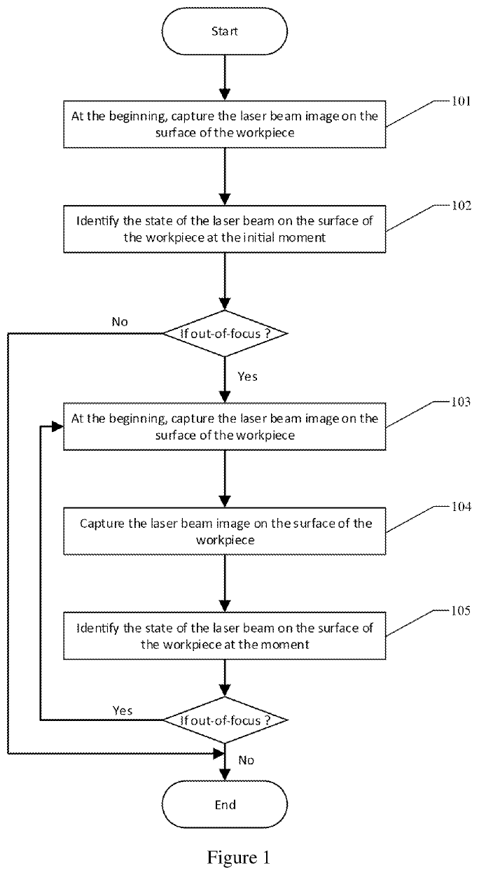

Referring to FIG. 1, the automatic surface tracing method according to the embodiment of the present invention includes:

Step 101: At the initial moment, a position image of the laser beam on the surface of the workpiece is captured.

Step 102: Identify the current state of the laser beam according to the position image captured at the initial moment, and execute the next step if the current state of the laser beam is out-of-focus.

Step 103: Adjust the height of the laser focal position relative to the workpiece's surface by adjusting the distance between the microscope objective and the surface of the workpiece.

Step 104: Capture a position image of the laser beam on the surface of the workpiece at each time the height adjustment operation is performed.

Step 105: Identify the real-time state of the laser beam according to the position image. If the laser beam is out-of-focus, return to step 103 to perform the next height adjustment operation. If the laser beam is in-focus, the process ends.

In this embodiment, image recognition technology is used to identify the state of the laser beam. While adjusting the relative distance between the microscope objective and the surface of the workpiece, the state of the laser beam is recognized until the laser beam is in-focus, thereby realizing the automatic surface tracing of the workpiece.

Specifically, the state of the laser beam can be identified according to a preset intensity detection algorithm. The intensity detection algorithm can be:

According to the position image, the laser beam's average light intensity on the workpiece's surface is calculated. The laser irradiation area at least covers the laser beam area on the surface of the workpiece.

By comparing the average light intensity with a light intensity threshold, the light intensity threshold is a preset minimum light intensity required to indicate a focused state;

If the average light intensity is lower than the light intensity threshold, the laser beam is determined to be out-of-focus. If the average light intensity is not lower than the light intensity threshold, the laser beam is determined to be in-focus.

When the laser beam is focused at different heights relative to the workpiece's surface, the laser beam's size is different. Therefore, in order to ensure the accuracy and efficiency of focal state recognition, the laser irradiation area is preferably larger than the laser beam area, so that in the process of adjusting the height of the laser focus, no matter how the laser beam changes, it is only necessary to calculate the average light intensity of the fixed area that completely covers the laser spot.

The average light intensity of the laser beam can be calculated according to the following method: first, calculate the grayscale value of the laser beam area in the position image, and then convert the grayscale value to calculate the average light intensity of the laser beam.

In addition to the focus detection algorithm, the state of the laser beam can also be identified according to the size of the laser beam, including:

Calculate the size of the laser beam in the position image.

Compare the size of the laser beam with a size threshold, the size threshold being a preset maximum size required to indicate that the laser beam is in-focus.

If the size of the laser beam is smaller than the size threshold, the laser beam is determined to be in-focus. If the size of the laser beam is not smaller than the size threshold, the laser beam is determined to be out-of-focus.

The out-of-focus state includes two cases: first, the laser focus is located above the specified focusing position, that is, the focal position is too shallow; second, the laser focus is located below the specified focusing position, that is, the focal position is too deep.

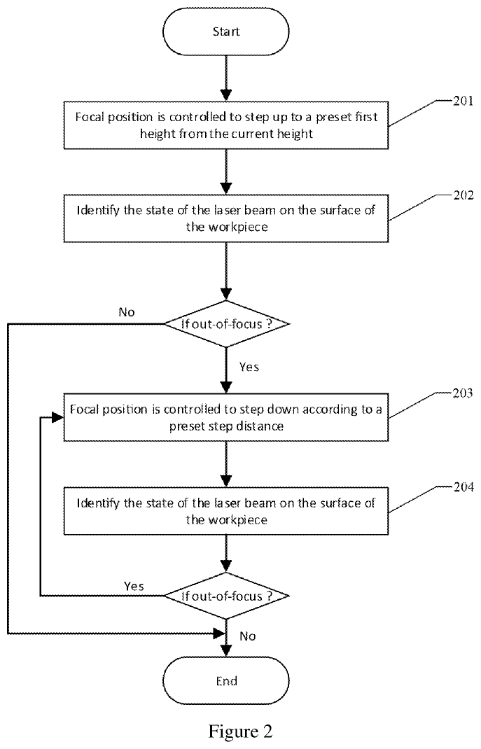

Based on the above-mentioned focus detection algorithm and laser beam size detection algorithm or other algorithms, when it is only possible to identify whether the laser beam is in out-of-focus and it is impossible to determine which case the current out-of-focus state belongs to, in order to improve the efficiency of automatic surface tracing, this invention provides a method to make the laser beam quickly be in-focus. Please refer to FIG. 2. This embodiment provides an optimal adjustment control strategy for the height adjustment operation of the laser focal position:

Step 201: Control the laser focal position to raise from current to preset first height.

Step 202: Identify the current state of the laser beam. If the laser beam is out-of-focus, continue to the next step. Otherwise, end the process.

Step 203: Control the laser focal position to lower by one step from the current height according to a preset step distance.

The preset step size needs to be smaller than the size of the focus region (usually sub-micron).

Step 204: Identify the current state of the laser beam. If the laser beam is out-of-focus, return to step 203. Otherwise, end the process.

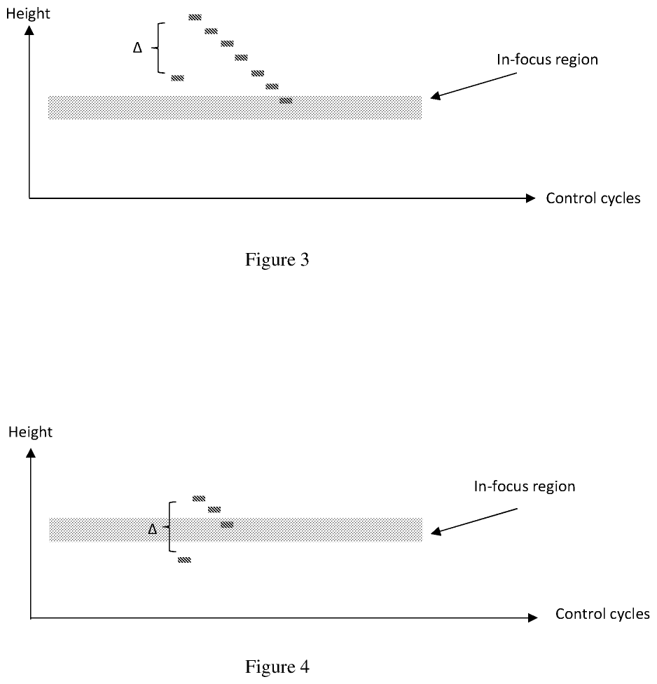

FIG. 3 shows the control curve achieved using the above adjustment control strategy when the out-of-focus state is the first case. Using this adjustment control strategy, the laser beam can be adjusted to be in-focus within seven cycles. FIG. 4 shows the control curve achieved using the above adjustment control strategy when the out-of-focus state is the second case. Under this adjustment control strategy, the laser beam can be adjusted to be in-focus within three cycles. Obviously, FIG. 3 shows the worst case in terms of longer convergence times. However, this complements the worst case that the image recognition technology cannot identify the out-of-focus cases of the laser beam and can greatly shorten the adjustment period.

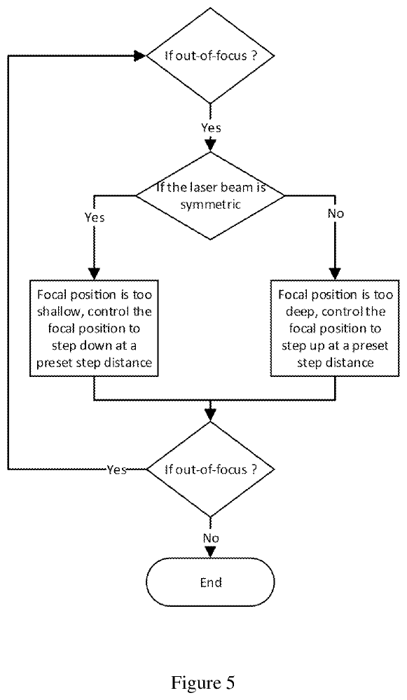

In some cases, due to the characteristics of the workpiece, if the focal position is too deep or too shallow, there is a situation where the spot symmetry is different. Generally speaking, when the focal position is too shallow, the symmetry of the laser beam can be better maintained because the laser beam does not pass through the workpiece to be processed. When the focal position is too deep, the laser beam is scattered by the workpiece because it passes through the workpiece, causing the broken symmetry of the laser beam. Therefore, in this case, the symmetry of the laser beam can be used to determine the focal position of the laser beam and adjust accordingly. The specific adjustment process is shown in FIG. 5, including:

In the out-of-focus state, identify whether the shape of the laser beam in the position image is symmetric;

If it is symmetric, it is determined that the focal position is too shallow, and the focal position is controlled to step down from the current height according to the preset step. If it is asymmetric, it is determined that the focal position is too deep, and the focal position is controlled to step up from the current height according to the preset step distance.

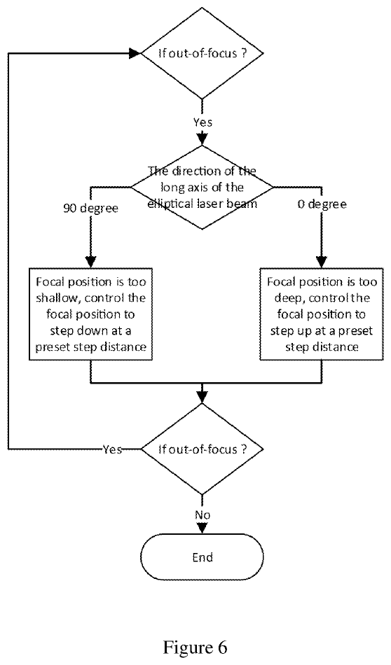

In other cases, by introducing astigmatism into the system (usually in the optical path of the observation, introduced by a phase plate or a cylindrical lens), the laser beam may be deformed into an elliptical shape when the focal position is too deep or too shallow. In general, the ellipse's long axis is rotated by 90° when the focus is too deep or too shallow. In this case, one can first define the angle between the ellipse's long axis and a certain direction (x-axis or y-axis), then use the angle to observe whether the focal position is too deep or too shallow. In this application example, when the focal position is too shallow, the angle is defined as 90°, and when the focus is too deep, the angle is defined as 0°. However, it should be pointed out that the definition here can be set flexibly. The specific adjustment process is shown in FIG. 6, including:

In the out-of-focus state, the angle between the long axis direction of the elliptical laser beam in the position image and the specified direction determines whether the focal position is too shallow or too deep.

If the focal position is too shallow, control the laser focal position to step down from the current height according to the preset step. If the focus is too deep, control the focal position to step up from the current height according to the preset step.

To sum up, by using the image recognition and control algorithm technology in this embodiment, the laser beam can be adjusted quickly and accurately to focus on the surface of the workpiece, and the processing precision and quality are effectively improved.

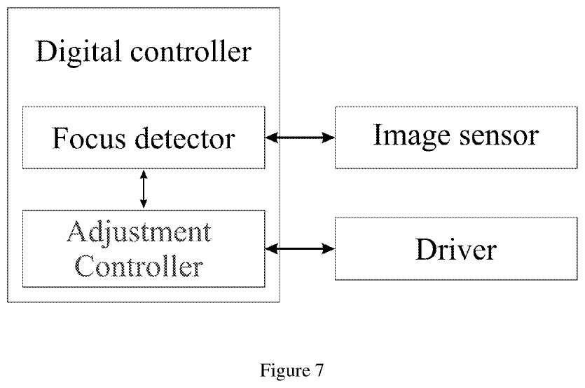

Referring to FIG. 7, an embodiment of the present invention further provides an automatic surface tracing system, including an image sensor, a driver, and a digital controller; the digital controller includes a focus detector and an adjustment controller.

The image sensor is used to capture the position image of the laser focus relative to the surface of the workpiece to be processed in real-time during the laser processing.

The driver, used as a motor, is used for adjusting the relative distance between the microscope objective and the surface of the workpiece according to the control command of the adjustment controller so as to realize the height adjustment operation of the focal position relative to the surface of the workpiece to be processed.

The focus detector is used to identify the state of the laser spot according to the position image captured in real-time at the initial moment and during the above-mentioned height adjustment operation. If the laser beam is identified as in-focus, it will send an in-focus signal to the adjustment controller.

The adjustment controller is used to control the driver to perform the height adjustment operation according to the preset height control algorithm when an out-of-focus signal is received at the initial moment until an in-focus signal from the focus detector is received.

In this embodiment, when it is recognized that the laser beam is out-of-focus at the initial moment, the driver is controlled to adjust the height of the focal position. During the height adjustment process, the state of the laser beam is identified based on the image recognition technology. When the out-of-focus state changes to the in-focus state, it means that the laser focus is at the surface of the workpiece, and the height adjustment operation can be stopped at this time.

It should be noted that the image sensor may be a CCD camera, or other devices with image or video acquisition functions may be used, which is not particularly limited. Taking a CCD camera as an example, the video of the laser beam relative to the surface of the workpiece can be captured according to the frame rate determined by the camera specifications, and then the position image at the required moment can be captured from the video. In order to adjust the focal position to the desired focus position, a higher frame rate can be used.

Further, the focus detector can identify whether the laser beam is in-focus according to the average light intensity, including:

The average light intensity calculation module is used to calculate the average light intensity of the laser beam on the surface of the workpiece according to the position image, and the laser irradiation area at least covers the laser beam area on the surface of the workpiece.

The light intensity comparison module compares the average light intensity with the light intensity threshold. The light intensity threshold is a preset minimum light intensity used to indicate that the laser beam is in-focus. If the average light intensity is lower than the light intensity threshold, the laser beam is determined to be out-of-focus. If the average light intensity is not lower than the light intensity threshold, the laser beam is determined to be in-focus.

Wherein the average light intensity calculation module, when calculating the average light intensity, is specifically used for: calculating the grayscale value of the laser irradiation area in the position image, converting the grayscale value to the average light intensity.

Optionally, the focus detector can also identify whether the laser beam is in-focus according to the laser beam size, including:

The beam size calculation module is used to calculate the size of the laser beam in the position image;

The beam size comparison module is used to compare the size of the laser beam with a size threshold. The size threshold is a preset maximum size that is used to indicate that the laser beam is in-focus. If the size of the laser beam is smaller than the size threshold, the laser beam is in-focus. Otherwise, it is determined that the laser beam is out-of-focus.

The adjustment controller, when controlling the driver to perform the height adjustment operation, is specifically used to: first control the focal position to increase from the current height to the preset first height, and then control the focal position to step down according to the preset step distance, the step distance is less than the size of the focal region (usually sub-micron).

In some cases, different spot symmetries may result if the focal position is too deep or too shallow. Based on this, the focus detector can also include a focal depth identification module, which is used to further identify whether the shape of the laser beam in the position image is symmetric when the laser beam is out-of-focus. If it is symmetric, it is determined that the laser beam is too shallow. Otherwise, it is determined that the laser beam is too deep.

In other cases, the too deep or too shallow focus may result in the laser beam deforming into an ellipse. Based on this, the focus detector can also include a focal depth recognition module, which is used to judge that the laser beam is in focus according to the angle between the long axis direction of the elliptical laser beam in the position image and the specified direction when the laser beam is out-of-focus to determine if the focal position is too shallow or too deep.

In the above two cases, two different situations of the out-of-focus state can be identified. Therefore, when the adjustment controller controls the driver to perform the height adjustment operation, it can achieve fast adjustment in the following ways: if the focal position is too shallow, it controls the focal position to step down from the current height according to the preset step. If the focal position is too deep, it controls the laser focus to step up from the current height according to the preset step.

Those of ordinary skill in the field can understand that all or part of the steps in the above-mentioned automatic surface tracing method can be completed by instructions, or completed by instructions to control relevant hardware, and the instructions can be stored in a computer-readable storage medium, and loaded and executed by processors.

To this end, the embodiments of the present invention further provide a storage medium in which a plurality of instructions are stored, and processors can load the instructions to execute the steps in the automatic surface tracing method provided by the embodiments of the present invention.

Wherein the storage medium may include: a read-only memory (ROM, Read Only Memory), a random access memory (RAM, Random Access Memory), a hard disk or an optical disk, etc.

As mentioned above, the above embodiments are only used to illustrate the technical solutions of the present invention, but not to limit them. Although the present invention has been described in detail with reference to the previous embodiments, those of ordinary skill in the field should understand: The technical solutions described in the embodiments can be modified, or some technical features thereof are equivalently replaced, and these modifications or replacements do not make the essence of the corresponding technical solutions depart from the spirit and scope of the technical solutions of the embodiments of the present invention.

1. An automatic surface tracing method for laser processing, the method comprising:
identifying a state of a laser beam on a surface of a workpiece to be processed;
when the state of the laser beam on the surface is an out-of-focus state, adjusting a relative distance between a laser focal position and the surface by adjusting a relative distance between a microscope objective for focusing the laser beam and the surface, while simultaneously identifying the state of the laser beam, until the state of the laser beam is determined to be an in-focus state;
wherein identifying the state of the laser beam includes: capturing a position image of the laser beam on the surface of the workpiece; and identifying the state of the laser beam according to the position image.

2. The automatic surface tracing method according to claim 1, wherein identifying the state of the laser beam further comprises:
using the position image, calculating an average light intensity of the laser beam on the surface of the workpiece within a laser irradiation area, said laser irradiation area at least encompassing an area of the surface irradiated by the laser beam;
comparing the average light intensity with a light intensity threshold, the light intensity threshold being a preset minimum light intensity required to indicate that the state of the laser beam is an in-focus state;
wherein: when the average light intensity is lower than the light intensity threshold, the state of the laser beam is determined to be an out-of-focus state; and when the average light intensity is equal to or greater than the light intensity threshold, it is determined that the laser beam is an in-focus state.

3. The automatic surface tracing method according to claim 2, wherein calculating the average light intensity of the laser beam on the surface comprises:
calculating a grayscale value of the laser irradiation area in the position image;
converting the calculated grayscale value to obtain the average light intensity.

4. The automatic surface tracing method according to claim 1, wherein identifying the state of the laser beam further comprises:
using the position image,
calculating a size of the laser beam on the surface;
comparing the size of the laser beam on the surface with a size threshold, the size threshold being a preset maximum size required to indicate that the state of the laser beam is an in-focus state;
wherein:
when the size of the laser beam is smaller than the size threshold, the state of the laser beam is determined to be an in-focus state, and
when the size of the laser beam is equal to or greater than the size threshold, the state of the laser beam is determined to be an out-of-focus state.

5. The automatic surface tracing method according to claim 2, wherein adjusting the relative distance between the laser focal position and the surface comprises:
using the position image, identifying whether a shape of the area of the surface irradiated by the laser beam is symmetric; and
when the shape of the area of the surface irradiated by the laser beam is symmetric, decreasing the relative distance between the microscope objective and the surface in a first direction by a preset step distance; and
when the shape of the area of the surface irradiated by the laser beam is asymmetric, decreasing the relative distance between the microscope objective and the surface in a second direction opposite the first direction by a preset step distance.

6. The automatic surface tracing method according to claim 2, wherein adjusting the relative distance between the laser focal position and the surface comprises:
introducing an astigmatism so that, when the state of the laser beam is an out-of-focus state, the shape of the area of the surface irradiated by the laser beam is elliptical;
using the position image, determining an angle between a long axis direction of the elliptical shape and a predetermined reference direction;
determining whether the angle is a first predetermined reference value or a second predetermined reference value;
and
when the angle is the first predetermined reference value, decreasing the relative distance between the microscope objective and the surface in a first direction by a preset step distance; and
when the angle is the second predetermined reference value, decreasing the relative distance between the microscope objective and the working surface in a second direction that is opposite the first direction by a preset step distance.

7. The automatic surface tracing method according to claim 1, wherein adjusting the relative distance between the laser focal position and the surface comprises:
adjusting the relative distance between the microscope objective and the surface in a first direction by a first preset step distance; and
adjusting the relative distance between the microscope objective and the surface in a second direction opposite the first direction by a second preset step distance smaller than the first preset step distance until the state of the laser beam is determined to be an in-focus state.

8. An automatic surface tracing system comprising a microscope objective for focusing a laser beam such that it has a laser focal position, the system further comprising an image sensor, a driver, a focus detector, and an adjustment controller;
wherein:
the image sensor is configured to capture a position image of the laser beam on a surface of a workpiece to be processed in real-time and provide said image to the focus detector;
the driver is configured to adjust a relative distance between the microscope objective and the surface according to a control command of the adjustment controller to perform an adjustment operation such that a relative distance between the laser focal position and the surface is adjusted;
the focus detector is configured to receive the position image from the image sensor and use said image to identify the state of the laser beam on the surface during the adjustment operation, the focus detector being further configured to send the identified state of the laser beam on the surface to the adjustment controller; and
the adjustment controller is configured to control the driver to perform the adjustment operation according to a preset height control algorithm when an out-of-focus state signal is received until an in-focus state signal is received.

9. The automatic surface tracing system according to claim 8, wherein the focus detector comprises:
an average light intensity calculation module, configured to calculate an average light intensity of the laser beam on the surface of the workpiece within a laser irradiation area, said laser irradiation area at least encompassing an area of the surface irradiated by the laser beam, using the received position image;
a light intensity comparison module; configured to compare the calculated average light intensity with a light intensity threshold;
wherein:
when the calculated average light intensity is lower than the light intensity threshold, the state of the laser beam is determined to be an out-of-focus state, and
when the average light intensity is equal to or greater than the light intensity threshold, the state of the laser beam on the surface is determined to be an in-focus state.

10. The automatic surface tracing system according to claim 9, wherein the average light intensity calculation module is configured to use the position image to calculate a grayscale value of the laser irradiation area, the calculated grayscale value then being converted to obtain the average light intensity.

11. The automatic surface tracing system according to claim 8, wherein the focus detector comprises:
a size calculation module configured to calculate a size of the laser beam on the surface using the received position image;
a size comparison module, configured to compare the calculated size of the laser beam on the surface to a size threshold;
wherein:
when the calculated size of the laser beam on the surface is smaller than the size threshold, the state of the laser beam is determined to be an in-focus state, and
when the calculated size of the laser beam on the surface is equal to or greater than the size threshold, the state of the laser beam is determined to be an out-of-focus state.

12. The automatic surface tracing system according to claim 9, wherein: the focus detector further comprises a focal depth identification module configured to identify when a shape of the area of the surface irradiated by the laser beam is symmetric; and the adjustment controller is configured to control the driver to perform the adjustment operation such that:
when the shape of the area of the surface irradiated by the laser beam is symmetric, the driver decreases the relative distance between the microscope objective and the surface of the workpiece in a first direction by a preset step distance;
when the shape of the area of the surface irradiated by the laser beam is asymmetric, the driver decreases the relative distance between the microscope objective and the surface of the workpiece in a second direction opposite to the first direction by a preset step distance.

13. The automatic surface tracing system according to claim 9, wherein the focus detector further comprises a focus depth identification module configured for use when an astigmatism is introduced so that, when the state of the laser beam is an out-of-focus state, the shape of the area of the surface irradiated by the laser beam is elliptical, said focus depth identification module further configured to determine, using the position image, an angle between a long axis direction of the elliptical shape and a predetermined reference direction,
and wherein the adjustment controller is specifically configured to control the driver to perform the focusing operation such that:
when the determined angle is a first predetermined reference value, the driver decreases the relative distance between the microscope objective and the surface in a first direction by a preset step distance; and
when the angle is the second predetermined reference value, the driver decreases the relative distance between the microscope objective and the surface in a second direction opposite the first direction by a preset step distance.

14. The automatic surface tracing system according to claim 8, wherein the adjustment controller is configured to control the driver to perform the adjustment operation such that:
the driver adjusts the relative distance between the microscope objective and the surface in a first direction by a first preset step distance; and
the driver adjusts the relative distance between the microscope objective and the surface in a second direction opposite the first direction by a second preset step distance smaller than the first preset step distance until the state of the laser beam is determined to be an in-focus state.

15. A storage medium, wherein the storage medium stores a plurality of instructions, and the instructions are adapted to be loaded by a processor to execute the steps in the automatic surface tracing method according to claim 1.

16. A storage medium according to claim 15, wherein in said method identifying the state of the laser beam further comprises:
using the position image, calculating an average light intensity of the laser beam on the surface of the workpiece within a laser irradiation area, said laser irradiation area at least encompassing an area of the surface irradiated by the laser beam;
comparing the average light intensity with a light intensity threshold, the light intensity threshold being a preset minimum light intensity required to indicate that the state of the laser beam is an in-focus state;
wherein: when the average light intensity is lower than the light intensity threshold, the state of the laser beam is determined to be an out-of-focus state; and when the average light intensity is equal to or greater than the light intensity threshold, it is determined that the laser beam is an in-focus state.

17. A storage medium according to claim 16, wherein in said method calculating the average light intensity of the laser beam on the surface comprises:
calculating a grayscale value of the laser irradiation area in the position image;
converting the calculated grayscale value to obtain the average light intensity.

18. A storage medium according to claim 15, wherein in said method identifying the state of the laser beam further comprises:
using the position image, calculating a size of the laser beam on the surface;
comparing the size of the laser beam on the surface with a size threshold, the size threshold being a preset maximum size required to indicate that the state of the laser beam is an in-focus state;
wherein:
when the size of the laser beam is smaller than the size threshold, the state of the laser beam is determined to be an in-focus state, and
when the size of the laser beam is equal to or greater than the size threshold, the state of the laser beam is determined to be an out-of-focus state.

19. A storage medium according to claim 15, wherein in said method adjusting the relative distance between the laser focal position and the surface comprises:
adjusting the relative distance between the microscope objective and the surface in a first direction by a first preset step distance;
adjusting the relative distance between the microscope objective and the surface in a second direction opposite the first direction by a second preset step distance smaller than the first preset step distance until the state of the laser beam is determined to be an in-focus state.
